(19) United States
(12) Patent Application Publication
(10) Pub. No.: US 2020/0266642 A1
(43) Pub. Date: Aug. 20, 2020

(54) Topping Up System for Rechargeable Devices

(71) Applicant: Nice Vice Corp., New York, NY (US)

(72) Inventors: Anastasia Alt, New York, NY (US); Randall Stainton, Margate, FL (US); Jordan Lejuwaan, Brooklyn, NY (US)

(73) Assignee: Nice Vice Corp., New York, NY (US)

(21) Appl. No.: 16/278,674

(22) Filed: Feb. 18, 2019

(51) Int. Cl. H02J 7/00; A24F 47/00

(52) U.S. Cl. CPC H02J 7/0045; H02J 7/0052; H02J 7/0047; H02J 2007/0059; H02J 2007/0062; H02J 2007/005; A24F 47/008

(57) ABSTRACT

A charger for a hand-held device, comprises: a sleeve for receiving the device, the sleeve containing a battery for charging the device; the sleeve including a power connector that connects to a corresponding power receptacle of the device when the device is received by the sleeve; a switching circuit for applying power from the battery to the power connector by default, and selectively disconnecting the battery from the device responsive to the user during intervals when activation of the device is desired.

### BACKGROUND

Rechargeable battery-powered devices of all sorts have become extremely popular. Some rechargeable devices are not operable while recharging is under way, and therefore must be removed from their charger prior to use.

### SUMMARY

Some handheld, battery-powered, rechargeable devices cannot operate while connected to a charger. In some cases, this may be due to a safety requirement imposed by the manufacturer or regulator of the devices; in other cases, the device cannot operate while connected to a charger whose supplied charging current is insufficient to both power the device and charge the device. There may be other reasons why manufacturers make this design choice. In some cases, this causes users to carry large supplemental battery packs with which to recharge the device, and which the user connects and disconnects from the device when moving between using the device and storing it.

An example of such a device might be a device with a relatively small battery and a large electric load, such as a heater. Electronic cigarettes, which are non-combustible delivery systems for vaporized or aerosolized materials like nicotine that a user desires to inhale, are such devices, and will be used in the following description of the invention to illustrate problems solved by the invention, features of the invention, and advantages of the invention. Other devices having similar power management and physical handling characteristics will also benefit from the invention, as will be apparent to the skilled artisan.

E-cigarettes, in brief, include a reservoir for holding a liquid known colloquially as “juice” from which heat will release a desired inhalant, a heating element and associated control circuits, and a battery and associated power management circuits, all contained in a small, handheld case. The case may be generally slender, and have a length with a port at one end convenient for inhaling generated vapor in a manner generally similar to the way a user draws on combustible tobacco products and devices. In order to meet the requirements of the form-factor, the battery is often quite small relative to the load presented by the heater and control circuits.

Conventional supplementary charging batteries have been found to be inconvenient and cumbersome due to the necessity to disconnect the supplementary charging battery each time the user desires to use the device, and then to remember to reconnect the device to the charging battery. Conventional supplementary charging batteries are further inconvenient and cumbersome due to the necessity to carry them separately from the device with which they are used. While there are phone cases with built-in supplementary batteries from which the phone can be charged, such as the Mophie® battery case (made by Mophie, Inc.) for Apple iPhone® and other handheld phones, those supplementary batteries remain continuously connected to the phone charging circuits while the phone is inserted in the case.

According to aspects of the invention, a charger for a hand-held device comprises: a sleeve for receiving the device, the sleeve containing a battery for charging the device; the sleeve including a power connector that connects to a corresponding power receptacle of the device when the device is received by the sleeve; a switching circuit for applying power from the battery to the power connector by default, and selectively disconnecting the battery from the device responsive to the user during intervals when activation of the device is desired.

The charger may further comprise: a button located on the sleeve in a location where the user customarily places a finger while holding the sleeve with the device received therein. In a variation, pressing the button removes power from the power connector and releasing the button applies power to the power connector. In another variation each press of the button changes a state of power at the power connector between a power applied state and a power removed state. In yet another variation, the sleeve with the device received therein retains an overall size and an overall shape suitable for manipulation by the user in a manner similar to manipulating the device alone.

In the following description reference is made to the accompanying drawings, which form a part hereof, and in which are shown example implementations. It should be understood that other implementations are possible, and that these example implementations are intended to be merely illustrative.

### DESCRIPTION OF THE DRAWINGS

FIG. 1 is a perspective view from a first angle of a charging case with supplemental battery for maintaining a charge on a Juul® e-cigarette device.

FIG. 2 is a perspective view from a second angle of the charging case of FIG. 1.

FIG. 3 is a perspective view from a third angle of the charging case of FIG. 1.

FIG. 4 is a perspective view from a fourth angle of the charging case of FIG. 1.

FIG. 5 is a schematic diagram of a power control system of a charging case according to the invention.

### DETAILED DESCRIPTION

The following section describes an exemplary embodiment of the invention illustrating various features and suggesting various options by which the invention may be practiced and implemented.

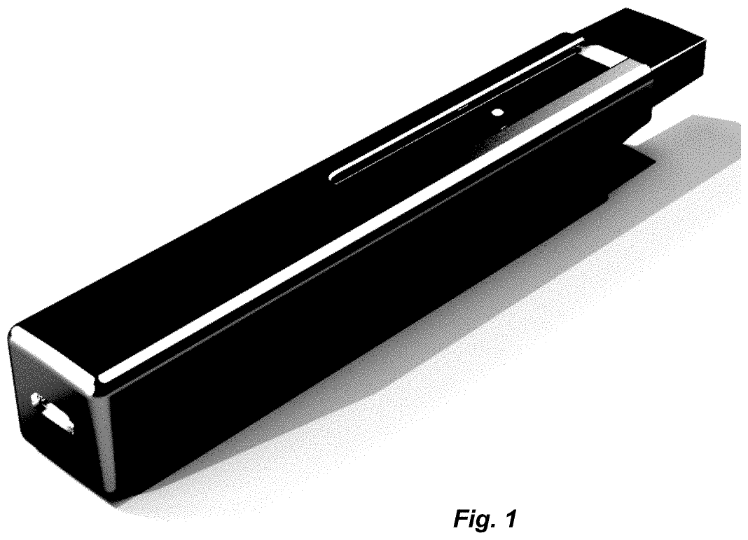

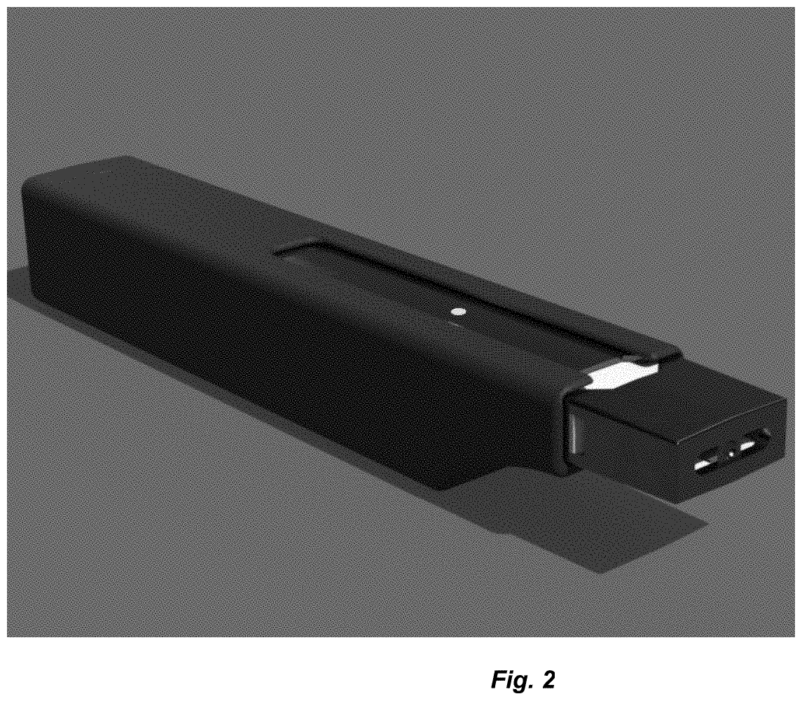

As shown in FIGS. 1-4, the charging case, 101, has a novel, functional form factor that enables unique and useful functionality. In particular, the outer boundaries of the charging case, 101, define an overall shape that roughly maintains the outer envelope of the device, 102, that it is designed to charge. The device, 102, in the exemplary embodiment a Juul® e-cigarette is the handheld device referred to hereinafter, has a long slender profile that the charging case parallels. Using a Juul e-cigarette is called vaping, after the act of inhaling vapor produced by a high-resistance heater in the device. The outer boundaries of the charging case, even if only slightly larger than those of the handheld device, define a volume sufficient to hold a supplemental battery substantially larger than the battery within the handheld device.

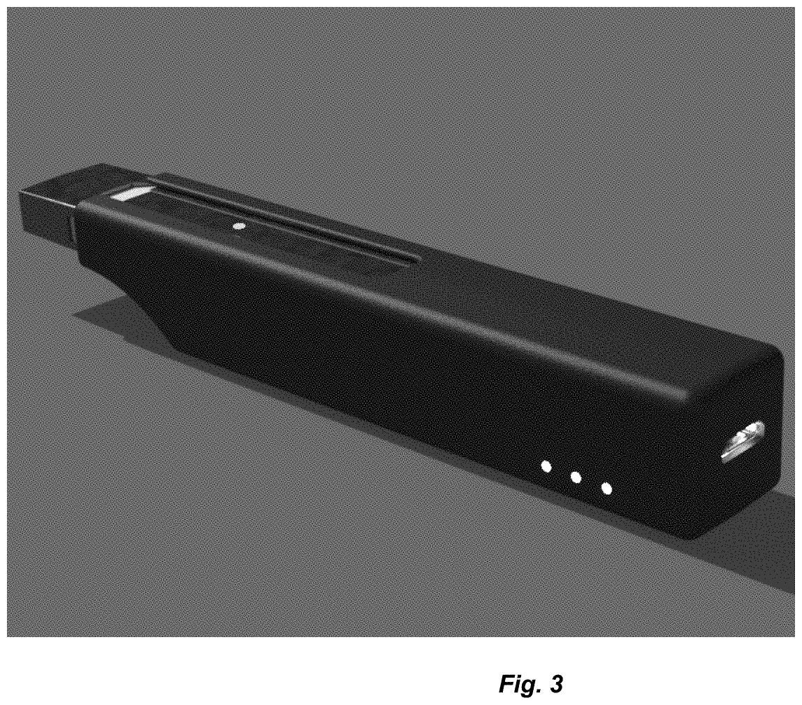

The handheld device, 102, fits into an elongated space, 103, within the charging device, 101, having an opening, 104, at one end of the charging device and around which the supplemental battery and other associated circuits and features are wrapped. In the example, there are device terminals for making an electrical connection for charging the battery contained within the handheld device near the end of the handheld device. The charging case has corresponding charging case output terminals for mating with those on the handheld device at a suitable matching location on the boundary defining the elongated space, 103. The charging case, 101, further has its own charging case input terminals, FIG. 3, 301, 302, 303, suitable for mating with those on a charger that is conventionally sold and/or provided with the handheld device. The charging terminals on the charging case may alternatively be any of a number of other types, such as a USB-C, -mini or -micro connector.

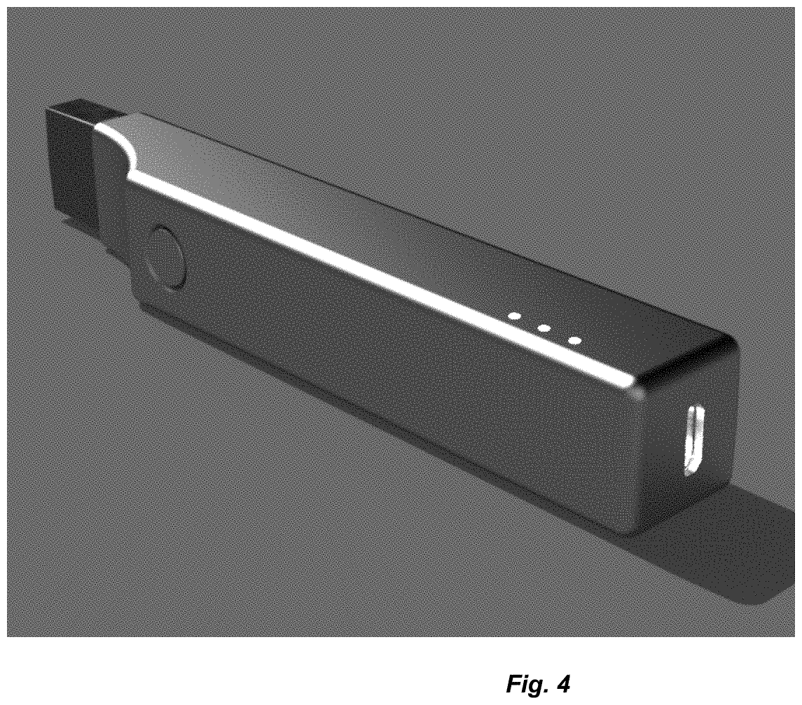

As further seen in FIGS. 1-4, the charging case has defined on the outer boundary thereof openings through which one or more indicator LEDs, 105, and a push-button, FIG. 4, 401, operate. The push-button, FIG. 4, 401, is located a position along the outer boundary of the charging case, 101, where one or more fingers naturally fall when the handheld device is in use. In the exemplary case of an e-cigarette, the button is located partway back from an end, 106, which the user places against the user's lips to draw on, coincidentally adjacent the charging case input terminals, FIG. 3, 301, 302, 303, where an index finger or other finger will naturally fall. The indicator LEDs, 105, can indicate various status information, such how much charge remains in the supplemental battery of the charging case, 101, or the state of the charging system when the supplemental batter is being recharged.

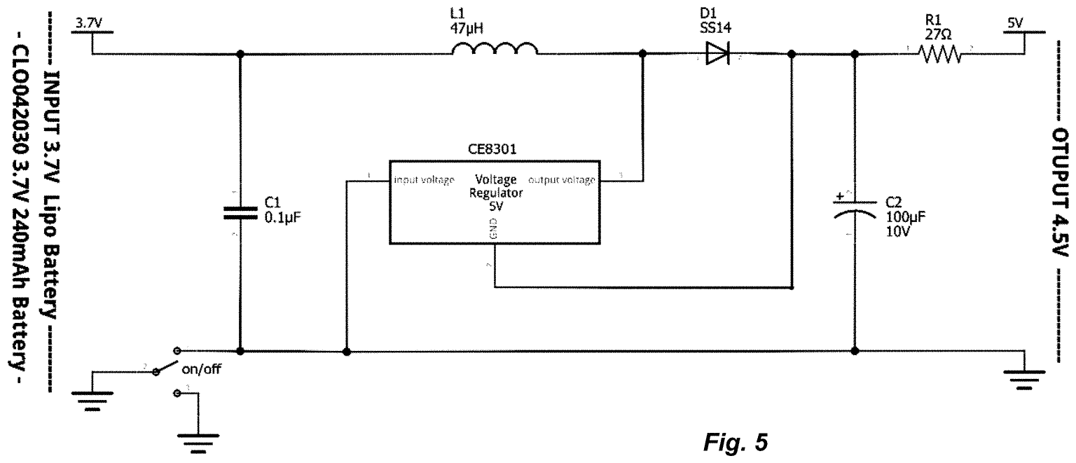

The button, FIG. 4, 401, functions to disconnect the supplemental battery from the charging case output terminals to which it is by default connected. The operation of the button and associated circuits is now described with reference to the schematic of FIG. 5.

The charger button, FIG. 4, 401; FIG. 5, on/off; allows the charger case to continuously replenish the handheld device battery while the handheld device is inserted in the charger case, but to momentarily, and without requiring any significant modification to the user's behavior, disconnect charging current from the handheld device charging terminals so the handheld device can be used both safely and without overloading the charging circuits.

This mode of operation is important for certain handheld devices, including e-cigarette devices. For example, the Juul e-cigarette cannot be used while being charged. Circuits in the Juul e-cigarette device prevent the heater from being activated while the device receives charging current. Thus, a user cannot charge and vape at the same time. Earlier solutions to this problem require the user to unplug the Juul device from the charger. However, the Juul device has a very limited battery life, typical of very small handheld devices having large power consumption characteristics. As a result, presently users carry large supplemental battery packs which they plug into and unplug from their Juul e-cigarette throughout a period of social activity during which they are intermittently vaping.

One characteristic of embodiments of the invention is that the user need not remove the handheld device, for example an e-cigarette, from the charging case to smoke. The combination of the button at a particularly accessible location on a case that does not appreciably expand the size of the handheld device, but momentarily cuts off the charging current to allow power to be applied by the device to the heater produces the novel result described above.

The charging case includes an output regulation circuit that switchably connects a large-capacity battery to the charging case output terminals, as follows. A positive terminal of a battery, such as a 3.7V, 200 mAH, Li-Polymer battery is connected to a high voltage rail of the output regulation circuit. A DC/DC step-up switching regulator, such as a CE8301 integrated regulator circuit, employing pulse-frequency modulation (PFM) converts the 3.7V input to a 5V output. A tank circuit including capacitor, C1, connected between a ground rail connected to the input terminal of the CE8301 regulation circuit and the positive terminal of the battery; and inductor, L1, connected between the positive terminal of the battery and an output terminal of an integrated regulator, govern the frequency around which a constant width pulse will be modulated, such that once filtered a desired output voltage is produced. The CE8301 integrated regulator further has a Gnd terminal connected to the output side of the output regulation circuit. The output terminal is connected to the Gnd terminal through a clamping Schottky diode, D1. On the output side of the output regulation circuit, filter capacitor, C2, and series resistor, R1, smooth the output and provide some load protection against accidental short circuit events. The output is a charging current produced by holding the voltage at the charging case output terminals to 4.5V. At the input side of the output regulation circuit, the push button switch, on/off, controls whether the negative terminal of the battery is connected to the ground rail of the output regulation circuit or not.

Operation of the push button may produce a momentary disconnect or a toggle between on and off with each press. The push button may slide to operate or press inward to operate.

In some alternate embodiments, the handheld device could be mechanically held in the charging case and either the charging case output terminals or the handheld device moved by mechanical action of the button to make and break contact between the charging case output terminals and the device charging terminals so as to produce the desired switching action by physical movement.

Having now described the invention with reference to an exemplary embodiment and some variations thereof, additional variations contemplated by the inventors as within the bounds of the invention should now be apparent. For example, the exemplary embodiment is an e-cigarette, but the invention may be used in connection with a charger for any handheld device having a characteristic that for safety or power management reasons, or any other desired reason, requires battery charging to cease whenever the handheld device is put into actual use.

What is claimed is:

1. A charger for a hand-held device, comprising:
a sleeve for receiving the device, the sleeve containing a battery for charging the device;
the sleeve including a power connector that connects to a corresponding power receptacle of the device when the device is received by the sleeve;
a switching circuit for applying power from the battery to the power connector by default, and selectively disconnecting the battery from the device responsive to the user during intervals when activation of the device is desired.

2. The charger of claim 1, further comprising:
a button located on the sleeve in a location where the user customarily places a finger while holding the sleeve with the device received therein.

3. The charger of claim 2, wherein pressing the button removes power from the power connector and releasing the button applies power to the power connector.

4. The charger of claim 2, wherein each press of the button changes a state of power at the power connector between a power applied state and a power removed state.

5. The charger of claim 2, wherein the sleeve with the device received therein retains an overall size and an overall shape suitable for manipulation by the user in a manner similar to manipulating the device alone.
